(19) United States
(12) Patent Application Publication
(10) Pub. No.: US 2013/0152977 A1
(43) Pub. Date: Jun. 20, 2013

(54) Method And Device for The Depollution Of A Pelliculated Reticle

(71) Applicants: Arnaud Favre, Annecy (FR); Smail Hadj Rabah, Annecy (FR); Julien Bounouar, Annecy (FR)

(72) Inventors: Arnaud Favre, Annecy (FR); Smail Hadj Rabah, Annecy (FR); Julien Bounouar, Annecy (FR)

(73) Assignee: ADIXEN VACUUM PRODUCTS, Annecy (FR)

(21) Appl. No.: 13/819,408

(22) PCT Filed: Sep. 6, 2011
(86) PCT No.: PCT/EP2011/065408

§ 371 Date: Feb. 27, 2013

(30) Foreign Application Priority Data
Sep. 8, 2010 (FR) FR1057120

(51) Int. Cl. B08B 5/00

(52) U.S. Cl. CPC B08B 5/00
USPC 134/26; 134/94.1

(57) ABSTRACT

The object of the present invention is a device for depolluting a non-sealed, confined environment (1) having a natural leakage (6) and including an interior space (9) bounded by a wall (7), comprising a depollution enclosure (11, 30) means (32, 42) for pumping gas and means (33, 43) for introducing gas. The depollution enclosure (11, 30) has at least two chambers (12, 13; 31, 41) separated by a sealing wall (14, 49). A first chamber (12, 31) is constituted by the part of the enclosure that is situated is contact with the wall (7) of the non-sealed, confined environment (1) and cooperates with first means for pumping (42) and first means for introducing gas (43), and a second chamber (13, 41) is constituted by the part of the enclosure which is situated in contact wife the natural leakage (6) from the non-sealed, confined environment (1) and cooperates with second means for pumping (42) and second means for introducing gas (43). The first and second means for pumping gas (32) and (42) have a pumping capacity which can vary independently, and the first and second means for introducing gas (33) and (43) having a gas injection flow rate which can vary independently. The device for depollating also has means to control the difference in pressure between the interior space (9) and the first chamber (12, 31).

The present invention pertains to a method for eliminating the molecular pollution located beneath the pellicle of a reticle or photomask and to the device for implementing this method.

A reticle is equivalent to a negative in photography: its active surface contains a piece of information to be printed on a carrier. It is used in transmittance for insolation and printing on semi-conductor substrates. An incident ray is focused on the active surface of the reticle, and the patterns contained in the active surface are then reproduced on the substrate. The pollution of the reticle has a direct effect on the image printed on the substrate, with the printing of defects. The semiconductor industry is seeking to reduce the dimensions of the recorded image to obtain increasingly smaller, integratable and lower-cost electronic components. As the dimensions of the reticle get smaller, the requirements in terms of pollution are becoming increasingly stringent. A reticle is therefore a vital, costly and complex element which it is sought to keep clean and operational.

At the end of its manufacture, the reticle is cleaned and inspected. If the reticle is clean and flawless, a pellicle is applied to it in order to protect its active surface. The pollutants likely to get deposited on the active surface of the reticle will thus get deposited on the pellicle. The pellicle is therefore aimed at protecting the reticle throughout its service life with the user. Pelliculation consists of a deposition of an optical membrane (consisting of parallel multilayer surfaces) with high transmittance and limited impact on the optical rays that pass through it. This pellicle is most often bonded to the rim of the active surface of the reticle and separated from it by a space. The atmosphere beneath the pellicle is then isolated from the atmosphere of the case used to transport the reticle. To prevent the pellicle from getting deformed, holes with low-conductance filters are designed on the sides of the pellicle. These holes fulfill a natural leakage role, balancing fee pressure between the atmosphere confined beneath the pellicle and fee external atmosphere.

It has recently been perceived that pollutants could still be present beneath the pellicle. The intensive use of reticles may give rise to defects on the active face of the reticle. These defects result from a reaction between the gases present between the substrate and the pellicle. For example, phenomena of crystal growth, especially the growth of ammonium sulphate crystals (NH₄)₂SO₄ can develop between the active face of the reticle and the pellicle, in the focusing area. These phenomena, which are amplified with the reduction of size in technologies, directly affect the steps of lithography (with the printing of defects).

Their position beneath the pellicle makes cleaning difficult. The cleaning of a reticle already provided with its pellicle is a lengthy, complex and costly process because the pellicle often needs to be removed for cleaning and then redeposited. This delicate operation has to be performed by the reticle manufacturers and not by the users, entailing loss of time and major additional costs in managing stocks related to the shortened service life of the reticles. It is therefore obligatory for intensive users of reticles to make sure that the environment beneath the pellicle is free of any molecular pollution.

To ensure efficient molecular depollution of a reticle without any need to remove the pellicle, a method has been proposed comprising an operation for pumping out or exhausting the internal atmosphere of such a non-sealed, confined environment and then restoring atmospheric pressure without opening the confined environment in order to prevent any operation likely to cause, for example, a particular form of pollution. The gases pass from within the non-sealed environment to the exterior and vice versa through a natural leakage point. In the case of a reticle, the passage of the gases is done by the holes with low-conductance filters provided on the sides of the pellicle.

However, it is then necessary to provide means to prevent any deterioration of the walls of the non-sealed, confined environment because these walls are not capable of withstanding significant differential pressures without deterioration. In the case of a reticle, the pellicle undergoes damage once the stresses applied to it cause deformation beyond its elastic limit. This limit depends on the type of pellicle which is not identical from one reticle to another. A pellicle usually cannot withstand a differential pressure greater than about 1 Pa because the deformation of the pellicle cannot exceed two millimeters, in terms of concavity or convexity, without damage.

To prevent this damage, the drop in pressure can be adjusted so that the pressure difference between the inside and the outside of the non-sealed, confined environment is at all times smaller than the difference in pressure that would prompt a mechanical deformation with a risk of damaging the wall. For a reticle, a drop in pressure from 1000 mbar to 10 mbar followed by the rise to atmospheric pressure takes more than five hours in these conditions. It can be understood that it is not possible to significantly accelerate this method without damaging the reticle. However, this period of time is far too lengthy to meet industrial needs. In practice, the time should not exceed 30 minutes for implementation, especially in plants manufacturing electronic chips.

The present invention is also aimed at proposing a device and a method for the efficient molecular depollution of a non-sealed, confined environment within a period of time shorter than that obtained with prior-art methods, a period that should be short enough to be compatible with production constraints.

The invention is also aimed at proposing a device and a method for the molecular depollution of a non-sealed, confined environment without requiring that this environment should be opened and without damaging the walls which have low resistance to pressure differences.

It is yet another aim of the invention to propose a device and a method for the efficient elimination of the pollutant compounds which may be situated between the active surface and the pellicle of a reticle, without removing the pellicle and requiring a smaller period of time than with prior-art methods.

The object of the present invention is a device for decollating a non-sealed, confined environment having a natural leakage and including an interior space bounded by a wall, comprising:
a depollation enclosure capable of containing the non-sealed, confined environment,
means for pumping gas out of the depollution enclosure,
means for introducing gas into the depollution enclosure.

The depollution enclosure has at least two chambers separated by a sealing, separating wall capable of withstanding a difference in pressure between the two chambers:
a first chamber constituted by the part of the enclosure that is situated in contact with the wall of the non-sealed, confined environment and cooperating with first means for pumping and first means for introducing gas.
a second chamber constituted by the part of the enclosure which is situated in contact with the natural leakage from the non-sealed, confined environment and cooperating with second means for pumping and second means for introducing gas,

the first and second means for pumping gas having a pumping capacity which can vary independently, and the first and second means for introducing gas having a gas injection flowrate which can vary independently, and the device for depolluting comprising means to control the difference between the pressure in the interior space of the non-sealed, confined environment and the pressure in the first chamber.

To significantly accelerate the molecular depollution of a non-sealed, confined environment, the pressure has to be maintained within the interior space of the non-sealed, confined environment so that it is as close as possible to the pressure prevailing outside, in the first chamber, throughout the depollution operation. By means of this device and the associated method, it is possible to achieve a depollution time of a few minutes (10 to 30 minutes for example) to a few hours (1 to 5 hours for example) depending on the pressure to be achieved and the optimizing of the method.

Advantageously, the first chamber has a volume smaller than the volume of the second chamber. Indeed, the volume of the first chamber must preserve a pressure as close as possible to the pressure prevailing in the interior space of the non-sealed, confined environment in order to prevent the deformation of its wall. To improve reactivity in the adjustment of the pressure, the volume of the first chamber must be as small as possible.

According to a first embodiment of the invention, the first chamber has windows transparent to light.

According to a preferred aspect, the device has means for measuring the deformation of the wall of the non-sealed, confined environment.

The means for measuring the deformation of the wall may include a laser which emits a light beam towards the wall of the non-sealed, confined environment and a photoreceiver which receives the light beam reflected by the wall of the non-sealed, confined environment.

According to one particular form of execution, the means for controlling the difference between the pressure in the interior space of the non-sealed, confined environment and the pressure in the first chamber are means for measuring the deformation of the wall of the non-sealed, confined environment.

According to another embodiment, the device further comprises means for activating to adapt the pumping speed in each of the chambers independently. To obtain a variation in the pumping capacity of the means for pumping, it is possible to control the rotation speed of the motor of the pump unit and/or the opening of a variable-conductance valve, for example.

According to yet another embodiment, the device further comprises means for activating to adapt the flow rate of gas injection into each of the chambers independently. To obtain a variation in the flowrate of gas injection into the depollution enclosure, it is possible to control the incoming gas flow by means of a mass flowmeter and/or by opening a variable-conductance valve for example.

Yet another object of the invention is a method for decollating a non-sealed confined environment having natural leakage and comprising an interior space bounded by a wall, by means of the previously described device comprising fee following steps:
placing the non-sealed, confined environment in a depollution enclosure comprising two chambers separated by a sealing, separating wall,
setting up the sealing of the separating wall on the non-sealed, confined environment,
pumping out the gas contained in the first chamber and the gas contained in the second chamber simultaneously, by adjusting the drop in pressure in each of the chambers independently, in such a way that the difference between the pressure in the interior space of the non-sealed, confined environment and the pressure in the first chamber are at any time smaller than the difference in pressure liable to prompt a mechanical deformation capable of damaging the wall of the non-sealed, confined environment,
stopping the pumping when the pressure in the interior space of the son-sealed, confined environment attains the desired low pressure value P0,
introducing gas into the first chamber and into the second chamber simultaneously, by adjusting the rise in pressure in each of the chambers independently, in such a way that the difference between the pressure in the interior space of the non-sealed, confined environment and the pressure in the first chamber are at any time smaller than the difference in pressure capable of prompting a mechanical deformation liable to damage the walls of the non-sealed, confined environment,
when atmospheric pressure is attained, extracting the non-sealed, confined environment from the depollution enclosure.

According to a first embodiment, once the desired low pressure value P0 is attained, the non-sealed, confined environment is allowed to rest at low pressure before the rise in pressure is effected.

The duration of rest at low pressure may be several minutes and preferably at least 15 minutes in order to obtain complete depollution. If it is desired to carry out a single purge operation, this duration may be far shorter, or even equal to zero.

According to a second embodiment, once the desired low pressure value P0 is attained, the rise in pressure is begun immediately.

Other features and advantages of the present invention shall appear from a reading of the following description of a preferred embodiment, given of course by way of a non-exhaustive illustration, and from the appended drawings of which:

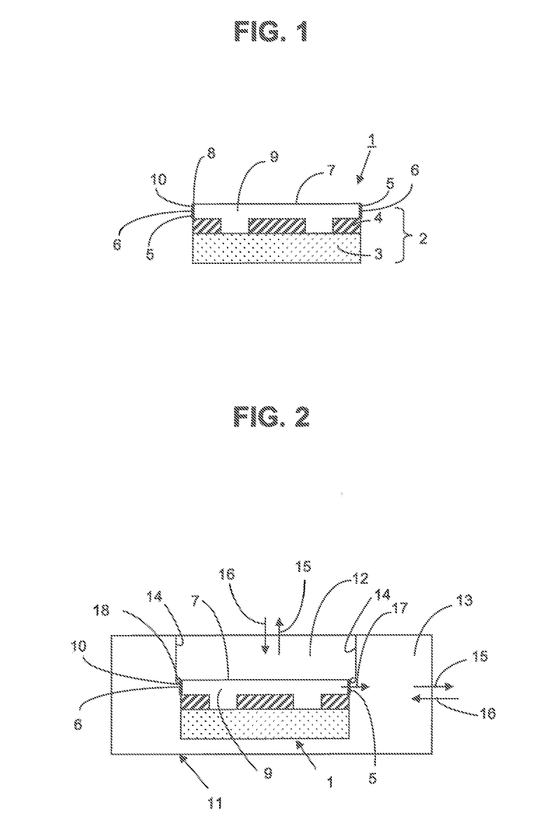

FIG. 1 is a schematic sectional view of a reticle provided with its pellicle,

FIG. 2 is a sectional view of a reticle in a depollution enclosure according to one embodiment of the invention,

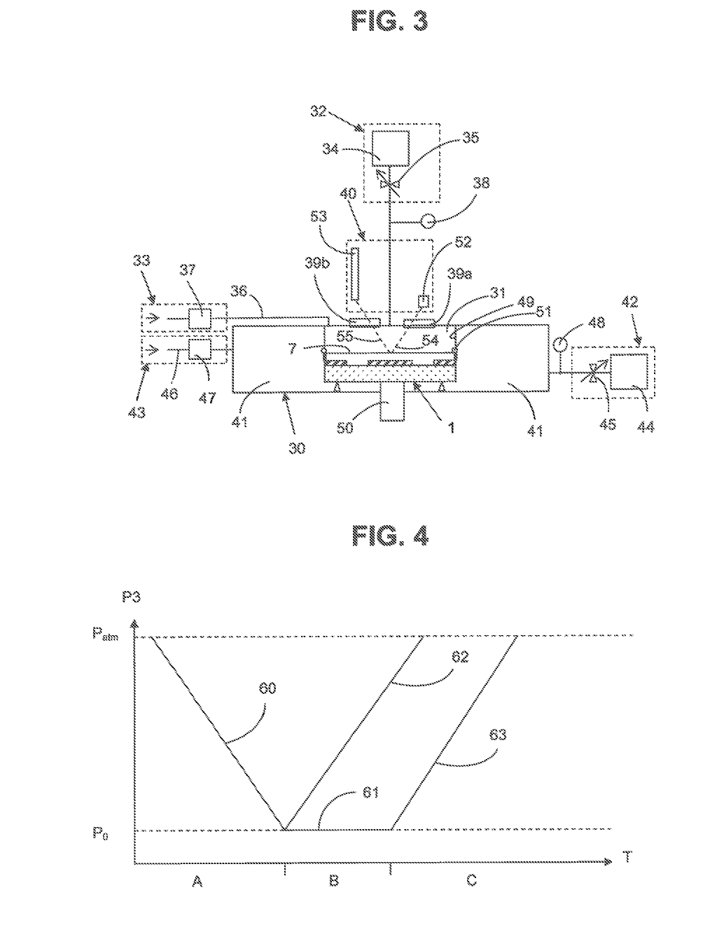

FIG. 3 is a schematic illustration of a device for depolluting according to one embodiment of the present invention used to depollute pelliculated reticles,

FIG. 4 is a schematic illustration of the progress of the pressure in the interior space beneath the pellicle during the sequencing of the different steps of the method, the pressure P3 in the interior space of the non-sealed, confined environment being indicated on the y axis and the progress of the method during the time T being indicated on the x axis.

In these figures, the different identical elements bear the same reference numbers.

The reticle 1 is shown schematically in FIG. 1. The pattern is reproduced by means of a laser beam or electronic beam for example, on a substrate 2 which is for example made of quartz 3 lined with a layer of chrome 4 on which the patterns are etched. For example, the substrate is a 152 mm by 152 mm square piece, 6.35 mm thick. The reticle 1, once etched, is dip-cleaned so as to eliminate the byproducts of the corrosive reaction. The reticle 1 obtained then undergoes several successive operations of cleaning, controlling and repairs if necessary. The substrate 2 is surrounded by a frame 5 about 2-6 mm thick. The frame 5 is for example a metal frame, for example made of anodized aluminium. After final cleansing, a protective pellicle 7 is applied to the substrate 2 and fixed to the upper surface 8 of the frame 5 in order to separate the interior space 9 included between the substrate 2 and the pellicle 7 from the external environment. Its aim is to protect the active face of the reticle 1 from particular pollution if any, while at the same time being positioned outside the focusing zones. The frame 5 may have several different geometrical shapes (rectangular, curved, octagonal, etc).

The lateral face 10 of the frame 5 has holes 6, with a diameter of about 1 mm, enabling pressure of fee same order as the external pressure to be maintained beneath the pellicle. These holes 6 have low-conductance filters fulfilling the natural leakage function. These holes 6 are one to four in number for example. This natural leakage necessarily has low conductance to protect the internal atmosphere of the interior space 9 bounded by the active surface of the reticle 1 and the pellicle 7. It can therefore be understood that an excessively fast pumping of the sealed depollution enclosure entails the risk of very rapidly lowering the gas pressure around the reticle 1. The gases contained in the interior space 9 do not have the time to escape by the holes 6. The interior atmosphere of the interior space 9 is then at a pressure higher than the external atmosphere in the enclosure, subjecting the pellicle 7 to differential pressure in the direction going from the interior to the exterior. The risk that excessive differential pressures may appear also exists during the steps for raising the pressure. The gases introduced into the enclosure then rapidly raise the gas pressure, whereas they penetrate more slowly through the natural leakage point 6 of the reticle 1. A differential pressure then appears in the direction going from the exterior to the interior. An excessive differential pressure applies a mechanical stress which may damage the pellicle 7.

In the embodiment of the invention shown in FIG. 2, a non-sealed, confined environment has been shown schematically. In this case, it is the reticle 1 in a depollution enclosure 11. The depollution enclosure 11 has two depollution chambers 12 and 13 separated by a sealing wall 14 resistant to the pressure difference. The first sealed chamber 12 occupies the part of the enclosure which is situated in contact with the pellicle 7 of the reticle 1. There is no communication between the chamber 12 and the holes 6, so as to totally confine the environment above the pellicle. The second sealed chamber 13 occupies the part of the enclosure 11 which is linked with the holes 6 of the reticle 1 thus enclosing the environment external to the chamber 12.

Each of the chambers 12, 13 can then be evacuated (arrows 15) or filled with gas (arrows 16) independently of each other. Consequently, the pressure P1 in the first chamber 12 can he different from the pressure P2 prevailing in the second chamber 13. The pressure P1 in the first chamber 12 is continually adjusted to the pressure P3 prevailing in the interior space 9 beneath the pellicle 7, in such a way that the pressure difference undergone by the pellicle 7 remains low, preferably below 1 Pa. Consequently, in the second chamber 13, the drop in pressure can be rapid so as to extract the polluted gases (arrows 17) from the interior space 9 through the low-conductance filters 6.

The importance of the tight sealing between the two chambers 12 and 13 can be understood. The sealing of the separating wall 14 on the reticle 1 can be obtained on the upper face 8 or on the lateral face 10 of the frame 5 above the holes provided with filters 6. In the present case, the sealing of the separating wall 14 on the reticle 1 is obtained for example by means of a seal 18 on the side face 10 of the frame 5. The chambers 12, 13 preferably have metal walls whose high resistance to pressure provides great freedom in driving of the pressures P1 independently in the first chamber 12 and P2 in the second chamber 13.

We now refer to FIG. 3 which illustrates an advantageous embodiment of the device comprising a depollution enclosure 13 according to the present invention.

A first sealed chamber 31 with a interior volume V1 occupies the part of the enclosure 30 which is situated in contact with the pellicle 7 of the reticle 1 and cooperates wife first means for pumping 32 and first means 33 for introducing gas which are proper to it. The means for pumping 32, which are capable of pumping gases out of the first chamber 31, comprise a pump unit 34 connected to the first chamber 31 by a conduit comprising a variable-flow valve 35. The means for introducing gas 33, which are capable of introducing a flow of gas into the first chamber 31, are connected to the first chamber 31 by a conduit 36 comprising a flow controller 37, such as a mass flowmeter or a variable-flow valve. The first chamber 31 is also equipped with a pressure gauge 38. Means (not shown) for controlling the difference between the pressure P3 in the interior space 9 beneath the pellicle 7 of the reticle 1 and the pressure P1 in the first chamber 31 are used to activate the valve 35 or the flow controller 37 according to the step of the method.

Preferably, two windows 39a and 39b, transparent to light, are inserted into the wall of the first chamber 31 which faces the pellicle 7 of the reticle 1. The first chamber 31 may further comprise means 40 for measuring the deformation of the pellicle 7.

A second sealed chamber 41 with an interior volume V2 occupies the part of the enclosure which is situated in contact with the holes 6 of the frame 5 of the reticle 1 and cooperates with second means for pumping 42 and second means for introducing gas 43 which are proper to it. The means for pumping 42, which are capable of pumping the gases out of the chamber 41, comprise a pump unit 44 connected to the second chamber 41 by a conduit including a variable-flow valve 45. The means for introducing gas 43, capable of introducing a flow of gas into the chamber 41, are linked to the chamber 41 by a conduit 46 comprising a flow controller 47, such as a mass flowmeter or a variable-flow valve. The second chamber 41 is also equipped with a pressure gauge 48. The chamber 41 is separated from the first chamber 31 by a sealing wall 49.

Inside the chamber 41, the reticle 1 is maintained by positioning means 50, comprising for example an actuator. These positioning means 50 are used especially to adjust the height of the reticle 1 in order to provide efficient sealing between the frame 5 of the reticle 1 and the separating wall 49 in contact by means of the seals 51.

The device for depolluting that has just been described is used to implement a method of depollution illustrated by FIG. 4.

In order to perform the depollution of the reticle 1, its positioning relatively to the separating wall 49 is adjusted by the positioning means 50 in order to provide complete sealing between the two chambers 31 and 41. The gases are then pumped into the chambers 31 and 41 (curve 60) by the means for pumping 32 and 42 respectively (step A). The means for pumping 32 and 42 have a variable pumping capacity. The pressure in each chamber 31, 41 is regulated by means of a variable-conductance valve 35, 45, placed in the inlet flow, which has an adjustable opening. The opening of the valves 35, 45 to a greater or smaller extent enables pumping at higher or lower speeds, in a totally independent manner, into each of the chambers 31, 41 respectively. The gases present in the interior space 9 are thus extracted by the holes 6 provided with low-conductance filters, without removing the pellicle.

Means for activating (not shown) are provided to adapt the pumping capacity of each pump unit 32 and 42. These means for activating are driven by means for controlling the difference between the pressure P3 in the interior space 9 beneath the pellicle 7 of the reticle 1 and the pressure P1 in the first chamber 31. The means for controlling the difference in pressure between the interior space 9 and the first chamber 31 are preferably means 40 for measuring the deformation of the pellicle 7 which represents the difference in pressure ΔP between the pressure P1 in the interior volume V1 of the first chamber 31 and the pressure P3 in the volume V3 of the interior space 9, communicating with the interior volume V2 of the second chamber 41 in which a pressure P2 prevails. The driving is done so that the measured value P3-P1 of the difference in pressure ΔP is at any time smaller than the threshold value of the difference in pressure, which is the value at which there would be a risk of causing a mechanical deformation capable of damaging the pellicle 7. The gas is extracted from the interior space 9 through holes 6 wife low-conductance filters made in the frame 5 supporting the pellicle 7 of the reticle 1 without any need to remove the pellicle 7.

Owing to the conductance of the holes 6, the pressure P3 in the interior space 9 is greater than the pressure P2 in the second chamber 41. It is possible to take account of this difference in pressure when pumping into the second chamber 41 and therefore to regulate the pressure P1 so that it is always slightly smaller than the pressure P1 in the first chamber 31. Consequently, the pressure P3 in the interior space 9 can he maintained at any time at a value of the same order as that of the pressure P1 in the first chamber 31. Consequently, the mechanical deformation of the pellicle 7 remains low enough not to cause any damage. With the conductance of the filters 6 being known, it is possible to make an exact computation of the difference in pressure P3-P2 that it causes, so as to regulate the pumping capacity of the means for pumping 42 of the second chamber 41 as a function of the pressure P1 in the first chamber 31.

The means 40 for measuring deformation, which can be seen in FIG. 3, can be used to control the deformation of the pellicle 7 through the use of a laser 52 and a photoreceiver 53 comprising a group of photoreceiver cells 1. The laser 52 emits a rectilinear light beam 54, a few millimeters wide, seat towards the pellicle 7 (preferably towards its centre) at an angle of a few degrees relatively to a direction perpendicular to the surface of the pellicle 7. The incident lightbeam 54 crosses the window 39a and gets reflected on the surface of the pellicle 7. The reflected lightbeam 55 crosses the window 39b and reaches the photoreceiver 53. Since the laser 52 and the photoreceiver 53 are in a fixed position, a deformation of the pellicle 7 results directly in the shifting of the reflected lightbeam 55 which is received by the photoreceiver 53.

It is therefore possible to use means 40 for measuring the deformation of the pellicle in order to make sure that the pressure P3 in the interior space 9 has very little difference with the pressure P1 in the first chamber 31. The means 40 for measuring the deformation of the pellicle 7 can thus be used to adjust the pumping speed in either of the chambers 31 and 41 as a function of the observed deformation of the pellicle 7.

Once a pressure P3 has been attained in the interior space 9, at a level equal to that of the sufficiently low pressure P0 that was set, it is possible to set apart a rest time (step B) in order to complete the desorption of the pollutant species (curve 61). To get a significant result from the viewpoint of depollution, it is preferable that the rest time should be at least 15 minutes. Naturally, if the pollution is very small, it may be preferred to perform a single purging operation which requires a shorter rest time, or even no rest time at all. In the latter case, the rise in pressure can take place immediately after the pumping is stopped (curve 62).

Following an idle time for example, it is possible to build up to atmospheric pressure Patm (curve 63) in the enclosure 30 by injecting a gas or a mixture of gases into the chamber 31 and 41 simultaneously (step C). The gas is introduced into the interior space 9 by the holes 6 provided with low-conductance filters, without removing the pellicle. Means for activating (not shown) such as a flow controller are designed for adapting the flow of injected gas independently by each of the means for introducing 33 and 43. The variably great or small magnitude of the injection flow enables a faster or slower rise in atmospheric pressure. These means for activating are driven by means (not shown) for controlling the difference between the pressure in the interior space 9 beneath the pellicle 7 of the reticle 1 and the pressure in the first chamber 31. The means for controlling the difference between the pressure in the interior space 9 and the pressure in the first chamber 31 are preferably means 40 for measuring the deformation of the pellicle 7 as a function of the difference in pressure ΔP between the first chamber 31 and the interior space 9 communicating with the second chamber 41. The gas is introduced from the interior space 9 through holes 6 with low-conductance filters made in the frame 5 supporting the pellicle 7 of the reticle 1 without any need to remove the pellicle 7. Once the atmospheric pressure has been restored in the chambers 31 and 41 and in the interior space 9, the reticle can be set apart from the positioning means 50 and finally removed from the depollution enclosure.

Naturally, the present invention is not limited to the embodiments described but can be the object of numerous alternative embodiments accessible to those skilled in the art without any departure from the spirit of the invention. In particular, it is possible, without departing from the framework of the invention, to modify the shape and the volume of the depollution chambers, use any known means to control and/or compare fee pressures in the depollution chambers and in the interior space of the non-sealed, confined environment.

1. A device for depolluting a non-sealed, confined environment having a natural leakage and including an inferior space bounded by a wall, the device comprising:
a depollution enclosure capable of containing the non-sealed, confined environment,
means for pumping gas out of the depollution enclosure, means for introducing gas into the depollution enclosure,
characterized in that the depollution enclosure has at least two chambers separated by a sealing, separating wall capable of withstanding a difference in pressure between the two chambers:
a first chamber formed at least in-part by the part of the depollution enclosure that is situated in contact with the wall of the non-sealed, confined environment and cooperating with first means for pumping and first means for introducing gas,
a second chamber formed at least in-part by the part of the depollution enclosure which is situated in contact with the natural leakage from the non-sealed, confined environment and cooperating with second means for pumping and second means for introducing gas,
the first and second means for pumping gas having a pumping capacity which can vary independently, and the first and second means for introducing gas having a gas injection flow rate which can vary independently,
and in that the device for depolluting further comprises means to control the difference between a pressure P3 in the interior space of the non-sealed, confined environment and a pressure P1 in the first chamber.

2. The device according to claim 1, wherein the first chamber has a volume V1 smaller than a volume V2 of the second chamber.

3. The device according to claim 1 wherein the first chamber comprises windows transparent to light.

4. The device according to claim 3, comprising means to measure the deformation of the wall of the non-sealed, confined environment.

5. The device according to claim 4, wherein the means for measuring the deformation of the wall of the non-sealed, confined environment includes a laser which emits a light beam towards the wall of the non-sealed, confined environment and a photoreceiver which receives the light beam reflected by the wall of the non-sealed, confined environment.

6. The device according to claim 4 wherein the means for controlling the difference between the pressure P3 in the interior space of the non-sealed, confined environment and the pressure P1 in the first chamber are means for measuring the deformation of the wall of the non-sealed, confined environment.

7. The device, according to claim 1 further comprising means for activating to adapt the pumping speed in each of the chambers independently.

8. The device according to claim 1 further comprising means for activating to adapt the flow rate of gas injection into each of the chambers independently.

9. The device according to claim 1 further comprising means to position the non-sealed, confined environment within the depollution enclosure.

10. A method for depositing a non-sealed confined environment having natural leakage and comprising an interior space bounded by a wall, the method comprising steps of:
placing the non-sealed, confined environment in a depollution enclosure comprising two chambers separated by a sealing, separating wall,
setting up the sealing of the separating wall on the non-sealed, confined environment,
pumping out gas contained in the first chamber and gas contained in the second chamber simultaneously, by adjusting a drop in pressure in each of the first and second chambers independently, in such a way that the difference between a pressure P3 in the interior space of the non-sealed, confined environment and a pressure (P1) in the first chamber is at any time smaller than a difference in pressure liable to prompt a mechanical deformation capable of damaging the wall of the non-sealed, confined environment,
stopping the pumping when the pressure P3 in the interior space of the non-sealed, confined environment attains a desired low pressure value P0,
introducing gas into the first chamber and into the second chamber simultaneously, by adjusting the rise in pressure in each of the chambers independently, in such a way that a difference ΔP between the pressure in the interior space of the non-sealed, confined environment and the pressure in the first chamber are at any time smaller than the difference in pressure capable of prompting a mechanical deformation liable to damage the wall of the non-sealed, confined environment,
when an atmospheric pressure Patm is attained, extracting the non-sealed, confined environment from the depollution enclosure.

11. A method of depollution according to claim 10, wherein once the desired low pressure value P0 is attained, the non-sealed, confined environment is allowed to rest at low pressure before the rise in pressure is effected.

12. A method of depollution according to claim 11, wherein a duration of rest at low pressure is at least 15 minutes.
